(19) United States
(12) Patent Application Publication
(10) Pub. No.: US 2024/0281642 A1
(43) Pub. Date: Aug. 22, 2024

(54) HIGH FREQUENCY SENSITIVE NEURAL NETWORK

(71) Applicant: Ramot at Tel-Aviv University Ltd., Tel-Aviv (IL)

(72) Inventors: David Mendlovic, Tel Aviv (IL); Dan Raviv, Tel Aviv (IL); Lior Gelberg, Tel Aviv (IL); Khen Cohen, Tel Aviv (IL); Mor-Avi Azulay, Tel Aviv (IL); Menahem Koren, Tel Aviv (IL)

(21) Appl. No.: 18/563,388

(22) PCT Filed: May 26, 2022
(86) PCT No.: PCT/IB2022/054972

§ 371 Date: Nov. 22, 2023

Related U.S. Application Data
(60) Provisional application No. 63/193,310, filed on May 26, 2021.

(51) Int. Cl. G06N 3/0464

(52) U.S. Cl. CPC G06N 3/0464

(57) ABSTRACT

A computer-implemented method of extracting high-frequency features from data, including receiving a first dataset; in a training phase, applying frequency-based guidance to learnable high-frequency filters in a neural network, the frequency based-guidance including promoting high eigenvalues associated with eigenvectors comprising the learnable high-frequency filters; extracting from the first dataset high-frequency features associated with the eigenvectors; and using the trained high-frequency filters to extract high-frequency features from a second dataset.

### CROSS-REFERENCE TO RELATED APPLICATIONS

This is a 371 application from international patent application PCT/IB2022/054972 filed May 26, 2022, which claims priority from U.S. Provisional Patent Application No. 63/193,310 filed May 26, 2021, which is expressly incorporated herein by reference in its entirety.

### FIELD

The subject matter disclosed herein relates in general to artificial intelligence, and in particular to a high-frequency sensitive neural network.

### BACKGROUND

Deep neural networks (DNNs) such as Deep Convolutional Neural Network (DCNNs), Generative Adversarial Networks (GANs), and Autoencoders, form the basis for many artificial intelligence (AI) technologies. Their applications are far-reached among of which one common application is in in Computer Vision.

DNNs suffer from spectral bias, a problem commonly referred to in the art as the “F-principal”. Due to this F-principal, DNNs are considered to generally adapt better to low frequencies rather than to high frequencies during training. Consequently, the trend is to use low frequency signals with DNNs rather than high-frequency signals.

### SUMMARY

In various embodiments, there is provided a computer-implemented method of extracting high-frequency features from data, including: receiving a first dataset; in a training phase, applying frequency-based guidance to learnable filters in a neural network, wherein the learnable filters are eigenvectors of the frequency-based guidance and wherein the frequency based-guidance is directed to obtaining high eigenvalues associated with high-frequency eigenvectors; and, in a detect phase, using the high-frequency eigenvectors to extract high-frequency features from a second dataset.

In some embodiments, the method further includes normalizing the high eigenvalues to a value in the range from 0 to 1.

In some embodiments, the method further includes normalizing a frequency spectrum to values ranging from 0 to 1.

In some embodiments, the method further includes defining an operator associated with the high eigenvalues.

In some embodiments, the method further includes controlling the spectrum of the learnable high-frequency filters.

In some embodiments, the method further includes generating a normalized N×N Laplacian Matrix for at least one learnable filter.

In some embodiments, the method further includes generating an adjacency matrix.

In some embodiments, the method further includes generating a diagonal degree matrix.

In some embodiments, the method further includes generating a loss function.

Optionally, the loss function includes a sum of a plurality of loss functions. Optionally, the loss function includes a cross-entropy loss function.

In some embodiments, the method further includes limiting the eigenvalues to a lower bound threshold and an upper bound threshold.

In some embodiments, the method further includes biasing the eigenvalues to the upper bound threshold.

In various embodiments, there is provided a system for extracting high-frequency features from data, including a neural network to receive a first dataset; a memory for storing data and executable instructions; and a controller configured to execute the executable instructions to result in performing the following steps: in a training phase, applying frequency-based guidance to learnable filters in the neural network, wherein the learnable filters are eigenvectors of the frequency-based guidance and wherein the frequency based-guidance is directed to obtaining high eigenvalues associated with high-frequency eigenvectors; and, in a detect phase, using the high-frequency eigenvectors to extract high-frequency features from a second dataset.

In various embodiments, there is a non-transitory computer readable system including instructions, that when executed by a processor, causes a system for extracting high-frequency features from data to perform the following steps: in a training phase, applying frequency-based guidance to learnable filters in a neural network, wherein the learnable filters are eigenvectors of the frequency-based guidance and wherein the frequency based-guidance is directed to obtaining high eigenvalues associated with high-frequency eigenvectors; and, in a detect phase, using the high-frequency eigenvectors to extract high-frequency features from a second dataset.

In some embodiments, the steps further include normalizing the eigenvalues to a value in the range from 0 to 1.

In some embodiments, the steps further include normalizing a frequency spectrum to values ranging from 0 to 1.

In some embodiments, the steps further include defining an operator associated with the high eigenvalues.

In some embodiments, the steps further include controlling the spectrum of the learnable high-frequency filters.

In some embodiments, the steps further include generating a normalized N×N Laplacian Matrix for at least one learnable filter.

In some embodiments, the steps further include generating an adjacency matrix.

In some embodiments, the steps further include generating a diagonal degree matrix.

In some embodiments, the steps further includes generating a loss function. Optionally, the loss function includes a sum of a plurality of loss functions. Optionally, the loss function includes a cross-entropy loss function.

In some embodiments, the steps further include limiting the high eigenvalues to a lower bound threshold and an upper bound threshold.

In some embodiments, the steps further include biasing the high eigenvalues to the upper bound threshold.

In some embodiments, the high-frequency eigenvectors are associated with a guiding polynomial matrix.

### BRIEF DESCRIPTION OF THE DRAWINGS

Non-limiting examples of embodiments disclosed herein are described below with reference to figures attached hereto that are listed following this paragraph. The drawings and descriptions are meant to illuminate and clarify embodiments disclosed herein and should not be considered limiting in any way. Like elements in different drawings may be indicated by like numerals. Elements in the drawings are not necessarily drawn to scale. In the drawings:

FIG. 1 is a flow chart of a method for extracting high-frequency features from data;

FIGS. 2A and 2B show flow diagrams of an algorithm by which a high-frequency sensitive neural network apparatus (HFSNNA) may operate to train a DNN and enhance the DNN's sensitivity to high-frequency features in data that the DNN processes;

FIG. 2C shows text boxes comprising definitions of HFSNNA loss functions for use with the algorithm shown in FIGS. 2B and 2C;

FIGS. 3A and 3B respectively show a schematic 3×3 kernel that may be used in a DNN and a 9×9 adjacency matrix generated responsive to the kernel;

FIG. 4 shows an exemplary HFSNNA DNN system;

FIG. 5 shows an exemplary architecture for a learnable HFFEM which may also serve as a basic building block for more complex applications;

FIG. 6 shows an exemplary architecture for a more complex application of HFFEM of FIG. 5 including a Parallel High-frequency Features Extraction Module (PHFFEM);

FIG. 7 shows an exemplary architecture of a Parallel High-frequency Features Extraction Module and Unconstrained (PHFEEM&U) which combines a PHFFEM with parallel unconstrained convolution of data X; and

FIG. 8 shows an example of the frequencies of the learned weights without and with application of the method for guidance toward high frequencies.

### DETAILED DESCRIPTION

Algorithms for using high-frequency features in a variety of Computer Vision tasks are in use today. Some use high pass filters such as, for example, the Prewitt filter, the Sobel filter, and the Canny filter. Others use extracted edge maps to construct high pass features and descriptors. Other use the orientation of the gradients as a descriptor for object detection tasks, for action recognition, and for image retrieval, among other tasks. These algorithms are also used in deep learning-based methods utilizing high-frequency features.

Deep learning-based method utilizing high-frequency features are in use today. A drawback with these methods is that they all use predefined high pass filters and therefore, there is no flexibility in the tasks they are able to perform. Applicant has realized that this lack of flexibility in the existing methods may be overcome by a deep learning-based method which includes a network which may be trained to learn data-driven high pass filters which are fully adaptive and optimized for the input data.

An aspect of an embodiment of the disclosure relates to a system and a method for enhancing sensitivity of a neural network to relatively high-frequency features of data by applying frequency-based guidance to high-frequency filters in a DNN during a training session. The system, which may be referred to hereinafter as a high-frequency sensitive neural network apparatus deep neural network (HFSNNA DNN) system, includes a high-frequency sensitive neural network apparatus or “HFSNNA” with an enhanced high-frequency features extraction module (HFFEM) and a high-frequency guidance loss module (HFGL). The HFFEM may include use of learnable weights to extract data-driven high-frequency features from the data. The HFFEM may be integrated in a convolution layer, optionally as the DNN's first layer, to allow extraction of the high-frequency features directly from the input data. The HFGL may enforce high-frequency filters in the HFFEM according to a given task, the input data, and the network architecture. The HFGL may collaborate with a corresponding target loss (e.g., cross-entropy loss), and may operate in the DNN to learn the optimal parameters with a bias towards the high-frequency features.

In some embodiments, the HFGL controls the spectrum of a set of learnable filters (referred to hereinafter as “spectrum guided filters” or SGF) in the HFFEM to enable them to converge into a set of high-frequency filters adapted for a given input data and DNN architecture. This is done by first defining an operator L which is guided to promote high frequencies by means of high eigenvalues. The SGF are then enforced to be operator eigenvectors corresponding to the promoted eigenvalues (high-frequency filters).

In some embodiments, the HFSNNA models as a graph's spatial structure common to at least one discrete spatial kernel comprised in and used by a DNN to process data. Nodes of the graph are a set of cells of the spatial structure which contain learnable weights that each of the at least one kernel respectively comprises to filter and extract features from the data. The HFSNNA generates a normalized Laplacian Matrix for the at least one kernel based on an adjacency matrix and a degree matrix that the HFSNNA determines for the common spatial structure. The normalized Laplacian Matrix is agnostic to the values of the respective weights in each of the at least one kernel. The HFSNNA constructs a polynomial matrix, hereinafter also referred to as a guiding polynomial matrix or guiding polynomial, in powers of the normalized Laplacian matrix multiplied by respective polynomial coefficients that are learnable from the data.

In some embodiments, the HFSNNA flattens the set of weights in each of the at least one kernel to a respective dedicated weight vector. The HFSNNA operates to converge the weight vectors to eigenvectors of the guiding polynomial and the eigenvalues of the guiding polynomial to relatively high values. Optionally, these relatively high eigenvalues range in value from 0.5-1.0 within a normalized spectrum range of 0-1. Convergence is obtained responsive to values of loss functions that are evaluated following each iteration of the data. The loss functions comprise a set of HFSNNA loss functions and a target loss function, such as optionally a cross-entropy loss function. By biasing the guiding polynomial to learn eigenvalues characterized by relatively high values and the respective weight vectors of the kernel to converge to corresponding eigenvectors, the kernels and the DNN to which they belong exhibit relatively enhanced sensitivity to high-frequency features of the data.

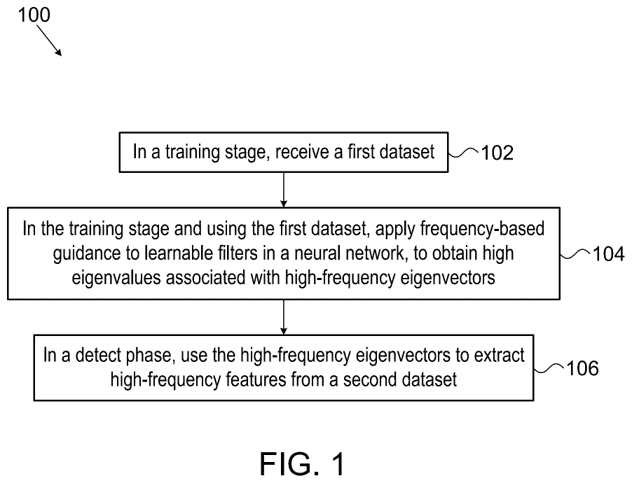

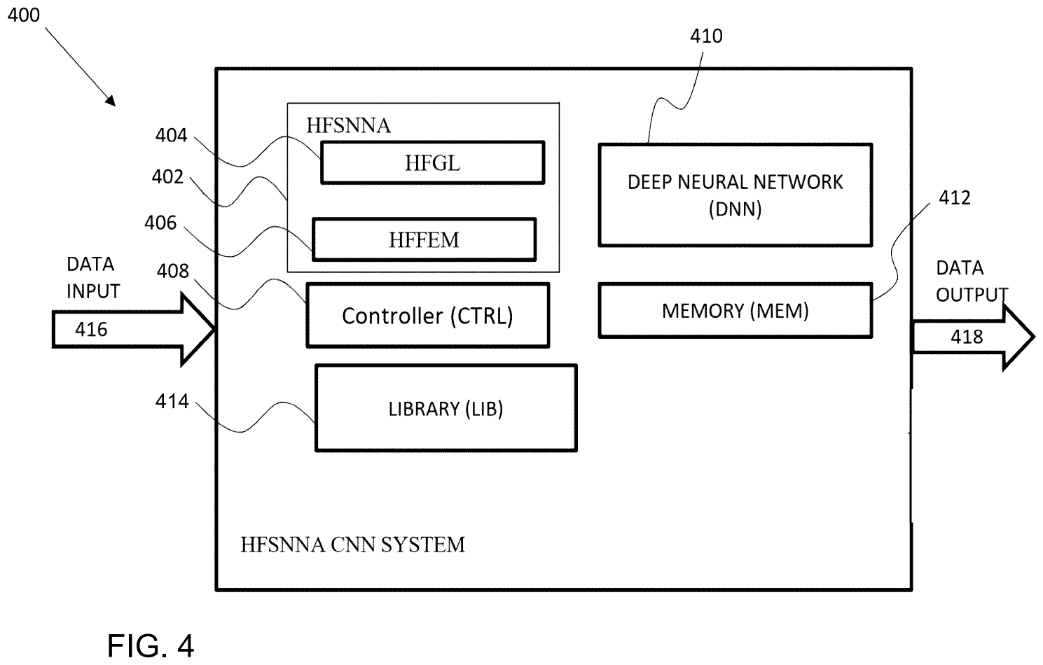

FIG. 1 shows a flow diagram of a method 100 of extracting high-frequency features from input data in a HFSNNA DNN system, the system described further on below with reference to FIG. 4. A first dataset is received for training in step 102. In step 104, using the first dataset, frequency-based guidance is applied to learnable filters in a neural network, to obtain high eigenvalues associated with high-frequency eigenvectors. In step 106, in a detect phase, the high-frequency eigenvectors to extract high-frequency features from a second dataset.

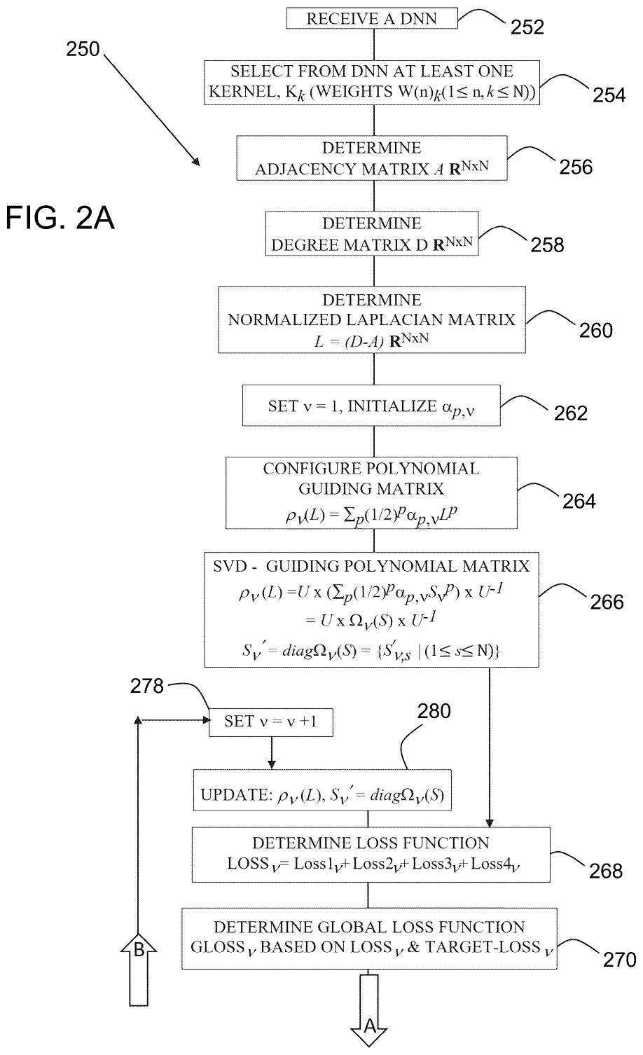

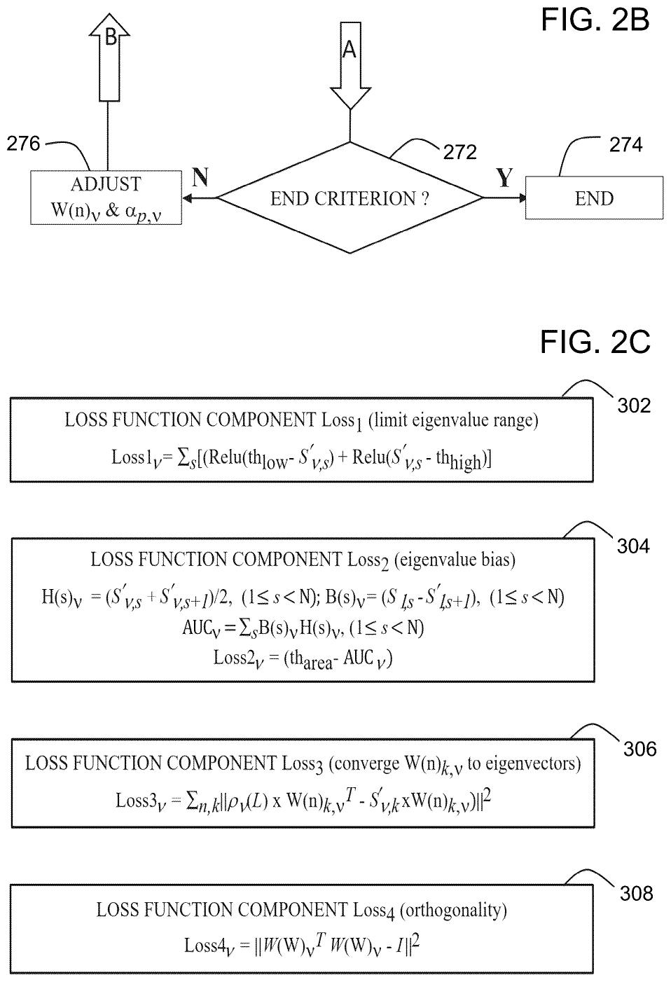

FIGS. 2A and 2B show a flow diagram of an algorithm 250 that the HFSNNA may optionally execute to enhance sensitivity of a neural network, optionally a DNN, to relatively high-frequency features of data that the neural network may process. Optionally, the DNN is a CNN.

In a block 252, the HFSNNA “receives” and is integrated to a DNN to train and enhance high-frequency sensitivity of the DNN.

In a block 254, at least one N×N kernel Kₖ, where the subscript k identifies a particular kernel of the at least one kernel, is selected for training by the HFSNNA to enhance high-frequency sensitivity of the DNN. Each of the at least one kernel is assumed to have its own set of weights W(n)ₖ (1≤n≤N) for filtering data that the DNN processes. Optionally a number of kernels Kₖ selected is N and (1≤k≤N).

In some embodiments, the HFSNNA interprets a kernel Kk selected for training as a graph in which cells of the kernel containing the kernel weights W(n)ₖ correspond to nodes of the graph.

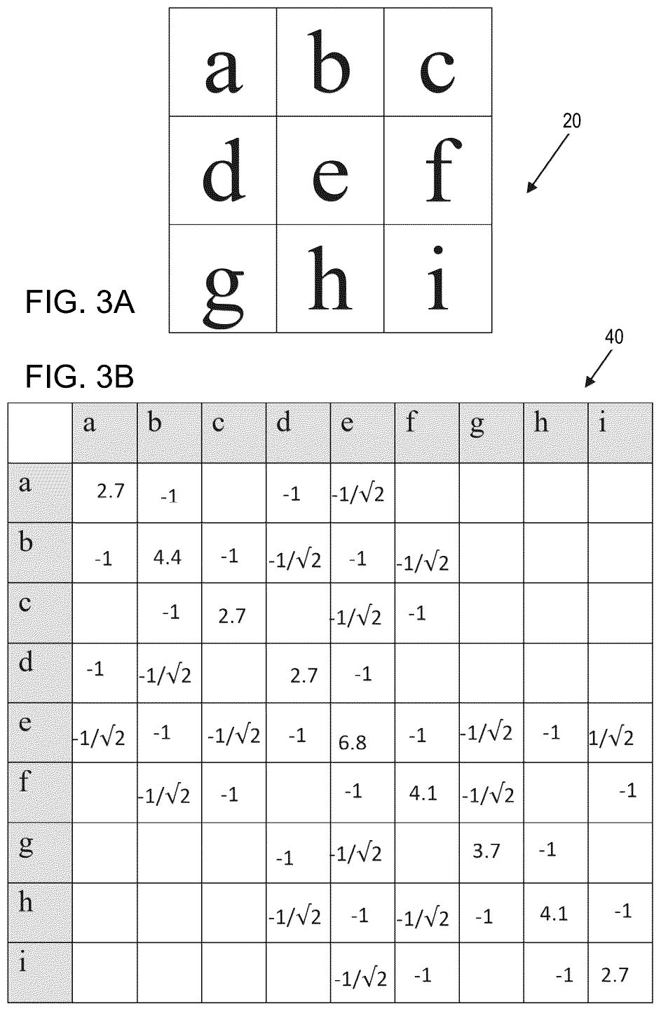

In blocks 256-260, the HFSNNA generates a N×N normalized Laplacian matrix based on the spatial structure of the selected kernels Kk. By way of example, FIG. 3A and FIG. 3B respectively illustrate a kernel 20 that may be processed by the HFSNNA as a graph, and a Laplacian matrix 40 that the HFSNNA generates and normalizes. Kernel 20, optionally as shown in FIG. 3A, is a 3×3 kernel including weights having values represented by a, b, c, . . . i, which values are also used to represent the cells in which the values respectively reside. Laplacian matrix 40, shown non-normalized in FIG. 3B, is a 9×9 matrix determined in accordance with the definition of a Laplacian matrix,

$$L = D - A . \qquad ( 1 )$$

In expression (1), A is an adjacency matrix and D is a diagonal degree matrix that are based on the spatial structure of kernel 20 and determining connectivity of “edges” between nodes a, b, c, . . . , i. Assuming that location of a cell in kernel 20 and a node representing the cell is given by row and column coordinates x and y respectively, connectivity of a cell located at given coordinates x, y to another cell of the kernel is optionally assigned a value:

$$\begin{matrix}1 , for other cells horizontally or \\ vertically located at coordinates ( x \pm 1 , y ) , ( x , y \pm 1 ) ; \\ 1 / √ 2 , for other diagonally cells located at coordinates \\ ( x \pm 1 , y \pm 1 ) ; and 0 , otherwise .\end{matrix} \} ( 2 )$$

The symbol L is hereinafter used to represent the normalized version of the Laplacian matrix 40 given by an expression

$$L = {D}^{- 1 / 2} ( D - A ) {D}^{- 1 / 2} . \qquad ( 3 )$$

In a block 262, the HFSNNA initializes a set of coefficients α_{p,v} for use in determining a N×N guiding polynomial matrix ρᵥ(L) and sets a training iteration counter, v, to 1.

In a block 264, the HFSNNA configures ρᵥ(L) as a function of powers “p” of the normalized Laplacian matrix L. In symbols the guiding polynomial matrix is given by an expression,

$${ρ}_{ν} ( L ) = {\sum }_{p} {( 1 / 2 )}^{p} {α}_{p , ν} {L}^{p} ( 1 \leq p \leq P ) \qquad ( 4 )$$

where the upper limit P on p is, optionally, a hyperparameter.

In a block 266, the HFSNNA performs a singular value decomposition of ρᵥL) to determine a diagonal matrix Q V (S) as a function of powers of a diagonal matrix S:

$${ρ}_{ν} ( L ) = U \times ( {\sum }_{p} {( 1 / 2 )}^{p} {α}_{p , ν} {S}_{ν}^{p} ) \times {U}^{- 1} = U \times {Ω}_{ν} ( S ) \times {U}^{- 1} \qquad ( 5 )$$

and an eigenvalue vector Sᵥ having elements that are eigenvalues of Ωᵥ (S) diagonally arranged in
descending ordered magnitude, in symbols,

$${S}_{ν}^{′} = diag {Ω}_{ν} ( S ) = \{ {S}_{ν , s}^{′} \vert ( 1 \leq s \leq N ) \} . \qquad ( 6 )$$

In block 268, an HFSNNA loss function LOSSᵥ is evaluated based on the initialized values of coefficients α_{p,v}, corresponding guiding polynomial matrix ρᵥ(L), and eigenvalue vector Sᵥ. In some embodiments LOSS V optionally comprises a sum of a plurality of loss function components Loss1ᵥ, Loss2ᵥ, Loss3ᵥ, and Loss4ᵥ, and may be written

$${LOSS}_{ν} = Loss {1}_{ν} + Loss {2}_{ν} + Loss {3}_{ν} + Loss {4}_{ν} . \qquad ( 7 )$$

Expressions defining the component loss functions are respectively summarized in text boxes 302, 304, 306 and 308 in FIG. 2D.

Loss function component, Loss1ᵥ, operates to limit eigenvalues that are components {S_{v,s}|(1≤s≤N)} of eigenvalue vector Sᵥ to values between a lower bound threshold th_{low} and an upper bound threshold th_{high} and may be written:

$$Loss {1}_{ν} = {\sum }_{s} [ ( Relu ( {th}_{low} - {S}_{ν , s}^{′} ) + Relu ( {S}_{ν , s}^{′} - {th}_{high} ) ] , \qquad ( 8 )$$

where Relu(x)≡max(0,x).

Loss function Loss2ᵥ, operates to bias eigenvalues S_{v,k} toward higher values within the range defined by th_{low} and th_{high} in expression (7). Loss2ᵥ, is a function of

$${AUC}_{ν} = {\sum }_{s} {B ( s )}_{ν} {H ( s )}_{ν} , where \qquad ( 9 )$$

$${H ( s )}_{ν} = ( {S}_{ν , s}^{′} + {S}_{ν , s + 1}^{′} ) / 2 , \text{} ( 1 \leq s N ) and {B ( s )}_{ν} = ( {S}_{1 , s} - {S}_{, s + 1} ) , \text{} ( 1 \leq s N ) , \qquad ( 10 )$$

and may be written:

$$Loss {2}_{ν} = ( {th}_{area} - {AUC}_{ν} ) ( 1 \leq s N ) . \qquad ( 11 )$$

Loss function Loss3ᵥ, flattens the set of weights W(n)ₖ in each kernel Kₖ to a respective dedicated weight vector and operates to converge the weight vectors to eigenvectors of guiding polynomial matrix ρᵥL) and may be written,

$${Loss {3}_{ν} = {\sum }_{n , k} ‖ {ρ}_{ν} ( L ) \times {W ( n )}_{k , ν}^{T} - {S}_{ν , k}^{′} \times {W ( n )}_{k , ν} ) ‖}^{2} \qquad ( 12 )$$

where ∥·∥² refers to the square of the norm of a matrix or vector.

Loss function Loss4ᵥ, operates to orthogonalize the weight vectors W(n)ₖ,v and may be written,

$$Loss {4}_{ν} = {‖ {W ( W )}_{ν}^{T} {W ( W )}_{ν} - I ‖}^{2} . \qquad ( 13 )$$

In expression (13) W(W)ᵥ is a matrix having columns that are weight vectors W(n)_{k,v}, which are represented in the argument of matrix N by N.

In a block 270, the HFSNNA determines a global loss function GLOSSᵥ based on LOSSᵥ and a target loss function such as a cross-entropy function that might be used to train the DNN in the absence of the HFSNNA.

In a decision block 272, the HFSNNA determines if the current training iteration v has satisfied an end criterion indicating that training has been completed. The end criterion may for example be based on a value of GLOSSᵥ and/or a limit to a number of iterations. If the criterion has been satisfied, the HFSNNA proceeds to a block 274 to end training. If on the other hand the criterion has not been satisfied, the HFSNNA proceeds to a block 276.

In block 276, the HFSNNA adjusts weight vectors W(n)ₖ,v and power coefficients α_{p,v} and proceeds to a block 278.

In block 278, the HFSNNA increases iteration number v by 1 and optionally thereafter to a block 280 to update guiding polynomial matrix ρᵥ(L) and eigenvalue vector Sᵥ=diagΩᵥ(S). Optionally, the HFSNNA proceeds to repeat actions in blocks 268-272.

FIG. 4 schematically illustrates an exemplary HFSNNA DNN system 400. HFSNNA DNN system 400 may include a HFSNNA 402 having a HFGL 404 and a HFFEM 406, a Controller (CTLR) 408, a Deep Neural Network (DNN) 410 which may optionally be a CNN, a Memory (MEM) 412, and a Library (LIB) 414. HFSNNA DNN system 400 may process INPUT DATA 416 and, by applying frequency-based guidance to high-frequency filters in DNN 410 during a training session, may generate OUTPUT DATA 418 which may include enhanced relatively high-frequency features associated with the input data. INPUT DATA 416 and OUTPUT DATA 420 may be associated with diverse applications related to computer vision and other AI applications. Examples of computer vision applications may include DeepFake applications, semantic segmentations, image classification, graph node classification, image tampering detection, image super resolution, and action recognition, among others.

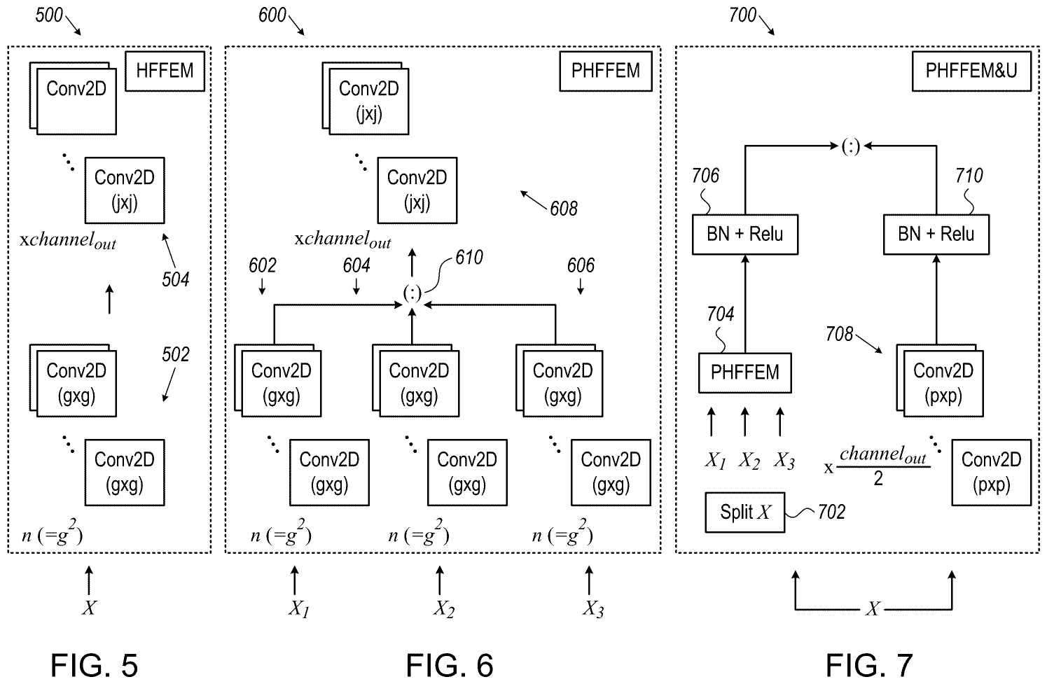

In some embodiments, HFSNNA 402 executes algorithm 250 shown in FIG. 2B. HFFEM 406 is configured to extract data-driven high-frequency features from INPUT DATA 416, optionally integrated in the first layer of DNN 410. Optionally, HFFEM 406 may include an architecture as shown further on below in FIGS. 5-7, and described further on with reference to the figures. HFGL 404 enforces high-frequency filters in HFFEM 406 according to a given task, the input data, and the network architecture, and operates in DNN 410 to monitor and learn the optimal parameters with a bias towards the high-frequency features. HFGL biasing towards the high-frequency features is selected by setting the values for the lower bound threshold th_{low} and the upper bound threshold th_{high} in equation (8) in algorithm 250.

In some embodiments, CTRL 408 may control the operation of all components in HFSNNA DNN system 400. MEM 412 may store software executable by CTRL 408 required to control operations of the HFSNNA DNN components. LIB 412 may store datasets which may be required during a training session for example, CelebDeepFakeV2, FaceForensics++, ImageNet, and PascalVOC2012, among others.

FIG. 5 shows an exemplary architecture for a learnable HFFEM 500 which may also serve as a basic building block for more complex applications. HFFEM 500, which may be similar to HFFEM 406 in FIG. 4, may apply any number or combination of steps described with reference to the method described with reference to FIGS. 2A-2C. A 2D (g×g) convolution layer 502 with n spectrum guided filters (SGF), each SGF filter shown as a block labelled Conv2D(g×g), is optionally used in the first layer to promote n eigenvalues associated with the high frequencies in the input data X. The output from each SGF in 2D convolution layer 502 is fed into a second 2D (j×j) convolution layer 504 including unconstrained convolution kernels shown as blocks Conv2D(j×j), which merges the SGF outputs to construct the high-frequency features. It is noted that the number of output channels at each layer may optionally be the same as the number of inputs at each layer to maintain minimal variations in architecture.

FIG. 6 shows an exemplary architecture for a more complex application of HFFEM 500 of FIG. 5. A Parallel High-frequency Features Extraction Module (PHFFEM) 600 may process RGB input data, as shown by parallel inputs X₁, X₂, and X₃, each representing a respective color, using parallel 2D (g×g) convolution layers 602, 604, and 606, optionally in the first layer. PHFFEM 600, which may be similar to HFFEM 406 in FIG. 4, may apply any number or combination of steps described with reference to the method described with reference to FIG. 2A-2C. Each 2D convolution layer 602, 604, 606 includes n SGF (each SGF is labelled Conv2D(g×g)), the n SGF in each convolution layer configured to operate on a different color, respectively (R, G, B). The output from each SGF in 2D convolution layer 602, 604, and 606 is fed into a second 2D (j×j) convolution layer 608 including unconstrained convolution kernels shown as blocks Conv2D(j×j), which merge the SGF outputs from each of the convolution layers to construct the high-frequency features. Prior to processing the SGF outputs at convolution layer 608, the SGF outputs from the convolution layers 602, 604, and 606 are channel-wise concatenated 610. It is noted that the number of output channels at each layer may optionally be the same as the number of inputs at each layer to maintain minimal variations in architecture. It is further noted that the HFGL, which may be similar to HFGL 404 in FIG. 4, operates on each parallel channel independently.

FIG. 7 shows an exemplary architecture of a Parallel High-frequency Features Extraction Module and Unconstrained (PHFEEM&U) 700 which combines a PHFFEM 704 with parallel unconstrained convolution of input data X. This architecture allows for using both high and low frequencies, when required. As shown, in one channel, the input data X is split by a splitter 702 into three different data inputs, as shown by parallel inputs X₁, X₂, and X₃. For example, each split data input may be associated with a color of an RGB input. PHFFEM 704 may be similar to PHFFEM 604 shown in FIG. 6. The output from PHFFEM 704 is input to a BN/Rectified Linear Unit 706 (BN/ReLU) to undergo batch normalization and ReLU activation. In a parallel channel, the input data X is fed into a 2D (p×p) convolution layer 708 including unconstrained convolution kernels shown as blocks Conv2D(p×p). The output from convolution layer 708 is then fed to a BN/ReLU 710, to also undergo batch normalization and ReLU activation. The outputs from BN/ReLU 706 and BN/ReLU 710 are then channel-wise concatenated 712.

Applicant conducted a number of tests to evaluate the efficacy of the disclosed apparatus and method for enhancing sensitivity of a neural network to relatively high-frequency features of data. For test purposes, the applications involved DeepFake detection and semantic segmentation, which are completely two different unrelated applications. A description of the tests and the results obtained is given below.

### A. Tests Performed for DeepFake Detection, and the Results Obtained

The DeepFake detection datasets used were VideoForensicsHQ, CeleDFv2, FaceForensics++, and Kaggle Deepfake Detection Challenge. VideoForensicsHQ was used as a benchmark to evaluate the model. The method's generalization was performed using cross dataset evaluation, with FaceForensics++used for training and CelebDFv2 was used for testing. The method was further evaluated in a scenario of a small dataset.

The frequency-guided models were implemented using operator L according to equation (3) with k=3 (order of the polynomial). The HFFEM is integrated as the first level of the tested architectures. th_{low}, and th_{high} in equation (8) were set to [0.7,1]. The loss function given in equation (7) by loss function components Loss1ᵥ, Loss2ᵥ, Loss3ᵥ, and Loss4ᵥ, are scaled by hyper-parameters scalars such that Loss1ᵥ, Loss2ᵥ, and Loss3ᵥ are each scaled by 0.5 and Loss4ᵥ is scaled by 0.15 to balance all constraints with the task's target loss (e.g., cross-entropy). A vanilla Xception model was modified into a frequency-guided Xception model by plugging in HFFEM instead of the model's original first layer, and HFGL was applied to it. Following are the results for DeepFake detection benchmark and cross dataset experiment which reflect an 11% accuracy improvement over its vanilla baseline:

### (a) Test Accuracy on VideoForensicsHQ Benchmark Published by [1]

| Model | Accuracy |
|---|---|
| Bayar [2] | 74.65% |
| Durall [3] | 61.98% |
| Wang [4] | 56.44% |
| MesoInc-4 [5] | 76.73% |
| Xception [6] | 88.59% |
| Xception-B [1] | 91.95% |
| Xception-S [1] | 99.45% |
| Xception-CS [1] | 97.12% |
| Xception-CST [1] | 97.78% |
| Frequency-guided Xception (according to this disclosure) | 99.72% |

### (b) AUC for Cross Dataset Experiment.* Denotes the Best AUC for the Frame-Level Models.

| Model | AUC |
|---|---|
| Xception [6] | 48.20 |
| Xception-c23 [6] | 66.65 |
| Capsule [7] | 57.50 |
| FWA [8] | 53.80 |
| DSP-FWA [8] | 64.13 |
| Face X-ray [9] | 74.76 |
| Discriminative attention [10] | 75.30 |
| TRN - frame-level [11] | 73.41 |
| TRN - video-level [11] | 76.65 |
| Frequency-guided Xception (according to this disclosure) | 76.78 |

Following are the results of a comparison with Kaggle's deep fake detection challenge. MCC denotes Mathew's correlation coefficient, relevant for imbalanced dataset:

| Model | Accuracy | AUC | MCC |
|---|---|---|---|
| EfficientNetB7 | 82.1% | 0.945 | 0.65 |
| Frequency-guided EfficientNetB7 | 86.4% | 0.95 | 0.73 |

### B. Tests Performed for Semantic Segmentation, and the Results Obtained

Edges and corner maps were used to perform semantic segmentation. The method was evaluated on Pascal-VOC 2012. The baseline model is DeepLabV3 with ResNet-101 backbone from GitHub repository. The HFFEM was plugged into DeepLabV3's backbone first layer instead of the original first layer and the HFGL was applied to construct the DeepLabV3 model. All models were trained until convergence. Following are presented the results of using original datasets and augmented train datasets to obtain the maximal mIoU over the validation set:
a). Mean IoU for DeepLabV3 model with ResNet-101 backbone vs. our DeepLabV3 with frequency-guided ResNet-101 model (FG-DeepLabV3). Experiment performed on Pascal-VOC 2012 dataset. Applicant's approach improves the validation set's best mIoU. Both models trained using a similar training scheme, preprocessing, and hyperparameters for a legitimate comparison.

| Model | mIoU@validation |
|---|---|
| DeepLabV3 | 74.40 |
| FG-DeepLabV3 (Applicant) | 74.91 |

b) Mean IoU for DeepLabV3 model with ResNet-101 backbone vs. our DeepLabV3 with frequency-guided ResNet-101 model (FG-DeepLabV3). Experiment performed on the augmented Pascal-VOC 2012 dataset. Applicant's approach improves the validation set's best mIoU. Both models trained using a similar training scheme, preprocessing, and hyperparameters for a legitimate comparison.

| Model | mIoU@validation |
|---|---|
| DeepLabV3 | 77.89 |
| FG-DeepLabV3 (Applicant) | 79.10 |

The implementation used Pytorch framework for all tests. Three common architectures were used—Xception, ResNet-101, and EfficientNetB7. The HFFEM was used as the first layer in each of the models so it can extract data-driven high-frequency features from the input data. Similar to the Deep Fake tests, the frequency-guided models were implemented using operator L according to equation (3) with k=3 (order of the polynomial). The HFFEM is integrated as the first level of the tested architectures. th_{low}, and th_{high} in equation (8) were set to [0.7,1]. The loss function given in equation (7) by loss function components Loss1ᵥ, Loss2ᵥ, Loss3 y, and Loss4ᵥ, are scaled by hyper-parameters scalars such that Loss1, Loss2ᵥ, and Loss3ᵥ are each scaled by 0.5 and Loss4ᵥ is scaled by 0.15 to balance all constraints with the task′ target loss (e.g., cross-entropy).

For DeepFake applications using the frequency-guided Xception and the frequency-guided EfficientNetB7, the HFFEM was implemented using the PHFFEM architecture of FIG. 6 with three parallel convolution layers with a kernel size 3×3, and stride 2 similar to the vanilla models. Each parallel convolution layer was set to have nine output channels matching the nine eigenvalues and nine eigenvectors. A 1×1 convolution layer was used for merging the information from all feature maps within and between the parallel modules. The output channel was set to 32 followed by batch normalization and ReLU activation, similar to the vanilla models.

For semantic segmentation applications, DeepLabV3 model was used with ResNet-101 as a backbone which uses a 7×7 kernel size with stride 2 and an output channel of 64 in its first convolution layer. To match the field of view of the 7×7 convolution layer, a 3×3 convolution layer with stride 2 and a 3×3 convolution layer with stride 1 were used for merging the information from all the feature maps within and between the parallel modules, followed by batch normalization and ReLU activation. The HFFEM was implemented using the PHFEEM&U architecture shown in FIG. 7 as both low and high frequencies are required for this application. The PHFFEM channel output was set to 32 and was later concatenated with 32 channel feature maps from the unconstrained parallel channels. The concatenation was performed following batch normalization and ReLU activation of the PHFFEM outputs and the unconstrained inputs. The result is 64 feature maps similar to the vanilla model.

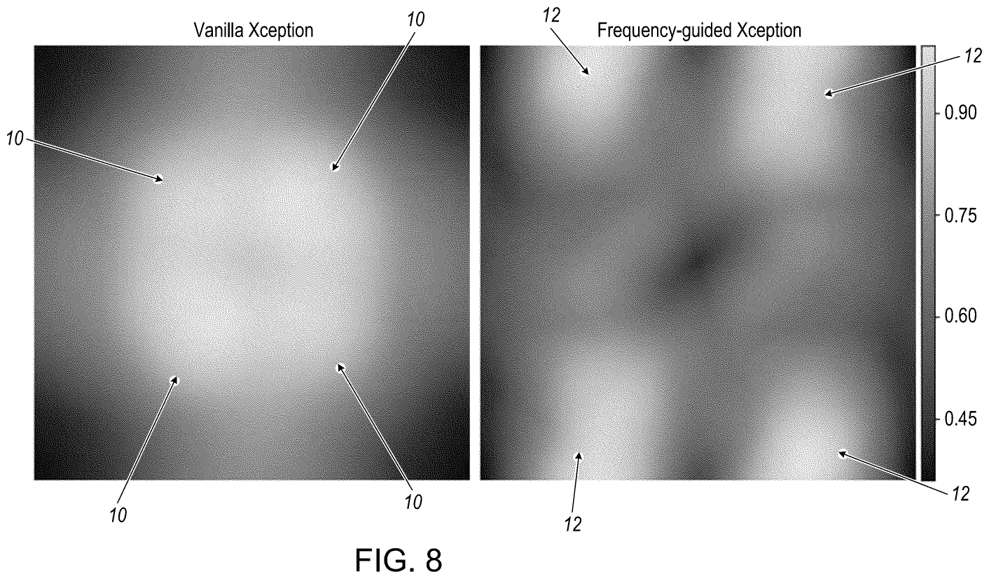

FIG. 8 which shows on the left side a vanilla Xception model first layer's average 2D Fourier transform without implementation of the method, and on the right a frequency-guided Xception model first layer's average 2D Fourier transform including implementation of the method for extracting high-frequency features from data. Both models are trained for Deepfake detection on Xception which is a convolutional model 71 layers deep. The figure on the left shows the lower frequencies of the weights 10 in the center of the image. This in contrast with the figure on the right which shows the higher frequencies of the weights 12 towards the corner of the image.

The example results above illustrate advantages of the method and system disclosed herein in terms of computer performance.

Some stages (steps) of the aforementioned method(s) may also be implemented in a computer program for running on a computer system, at least including code portions for performing steps of the relevant method when run on a programmable apparatus, such as a computer system or enabling a programmable apparatus to perform functions of a device or system according to the disclosure. Such methods may also be implemented in a computer program for running on the computer system, at least including code portions that make a computer execute the steps of a method according to the disclosure.

A computer program is a list of instructions such as a particular application program and/or an operating system. The computer program may for instance include one or more of: a subroutine, a function, a procedure, a method, an implementation, an executable application, an applet, a servlet, a source code, code, a shared library/dynamic load library and/or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

Unless otherwise stated, the use of the expression “and/or” between the last two members of a list of options for selection indicates that a selection of one or more of the listed options is appropriate and may be made.

It should be understood that where the claims or specification refer to “a” or “an” element, such reference is not to be construed as there being only one of that element.

All references mentioned in this specification are herein incorporated in their entirety by reference into the specification, to the same extent as if each individual reference was specifically and individually indicated to be incorporated herein by reference. In addition, citation or identification of any reference in this application shall not be construed as an admission that such reference is available as prior art to the present disclosure.

While this disclosure has been described in terms of certain embodiments and generally associated methods, alterations and permutations of the embodiments and methods will be apparent to those skilled in the art. The disclosure is to be understood as not limited by the specific embodiments described herein, but only by the scope of the appended claims.

### LIST OF REFERENCES

[1] G. Fox et al., ArXiv, abs/2005.10360, 2020.
[2] Belhassen Bayar at al., Proceedings of the 4th ACM Workshop on Information Hiding and Multimedia Security, pages 5-10, 2016.
[3] Ricard Durall et al., arXiv preprint arXiv:1911.00686, 2019.
[4] Sheng-Yu Wang et al., Proceedings of the IEEE/CVF Conference on Computer Vision and Pattern Recognition, pages 8695-8704, 2020.
[5] Darius Afchar et al., 2018 IEEE International Workshop on Information Forensics and Security (WIFS), pages 1-7. IEEE, 2018.
[6] Frangois Chollet, Proceedings of the IEEE Conference on Computer Vision and Pattern Recognition, pages 1251-1258, 2017.
[7] Huy H Nguyen et al., arXiv preprint arXiv:1910.12467, 2019.
[8] Yuezun Li et al., IEEE Conference on Computer Vision and Pattern Recognition Workshops (CVPRW), 2019.
[9] Lingzhi Li et al., Proceedings of the IEEE/CVF Conference on Computer Vision and Pattern Recognition, pages 5001-5010, 2020.
[10] Tianfei Zhou et al., Proceedings of the IEEE/CVF Conference on Computer Vision and Pattern Recognition (CVPR), pages 5778-5788, June 2021.
[11] Iacopo Masi et al., ECCV, 2020

1. A computer-implemented method of extracting high-frequency features from data, comprising:
receiving a first dataset;
in a training phase and using the first dataset, applying frequency-based guidance to learnable filters in a neural network, wherein the learnable filters are eigenvectors of the frequency-based guidance and wherein the frequency based-guidance is directed to obtaining high eigenvalues associated with high-frequency eigenvectors; and
in a detect phase, using the high-frequency eigenvectors to extract high-frequency features from a second dataset.

2. The method of claim 1, further comprising normalizing the high eigenvalues to a value in the range from 0 to 1.

3. The method of claim 1, further comprising normalizing a frequency spectrum to values ranging from 0 to 1.

4. The method of claim 1, further comprising defining an operator associated with the high eigenvalues.

5. The method of claim 1, further comprising controlling the spectrum of the learnable filters.

6. The method of claim 1, further comprising generating a normalized N×N Laplacian Matrix for at least one learnable filter.

7-13. (canceled)

14. A system for extracting high-frequency features from data, comprising:
a neural network to receive a first dataset;
a memory for storing data and executable instructions; and
a controller configured to execute the executable instructions to result in performing the following steps:
in a training phase and using the first dataset, applying frequency-based guidance to learnable filters in a neural network, wherein the learnable filters are eigenvectors of the frequency-based guidance and wherein the frequency based-guidance is directed to obtaining high eigenvalues associated with high-frequency eigenvectors; and
in a detect phase, using the high-frequency eigenvectors to extract high-frequency features from a second dataset.

15. The system of claim 14, wherein the steps further comprise normalizing the high eigenvalues to a value in the range from 0 to 1.

16. The system of claim 14, wherein the steps further comprise normalizing a frequency spectrum to values ranging from 0 to 1.

17. The system of claim 14, wherein the steps further comprise defining an operator associated with the high eigenvalues.

18. The system of claim 14, wherein the steps further comprise controlling the spectrum of the learnable high-frequency filters.

19. The system of claim 14, wherein the steps further comprise generating a normalized N×N Laplacian Matrix for at least one learnable filter.

20. The system of claim 14, wherein the steps further comprise generating an adjacency matrix.

21. The system of claim 14, wherein the steps further comprise generating a diagonal degree matrix.

22-27. (canceled)

28. A non-transitory computer-readable medium including instructions, that when executed by a processor, causes a system for extracting high-frequency features from data to perform the following steps:
receiving a first dataset;
in a training phase and using the first dataset, applying frequency-based guidance to learnable filters in a neural network, wherein the learnable filters are eigenvectors of the frequency-based guidance and wherein the frequency based-guidance is directed to obtaining high eigenvalues associated with high-frequency eigenvectors; and
in a detect phase, using the high-frequency eigenvectors to extract high-frequency features from a second dataset.

29. The non-transitory computer-readable medium of claim 28, wherein the steps further comprise normalizing the high eigenvalues to a value in the range from 0 to 1.

30. The non-transitory computer-readable medium of claim 28, wherein the steps further comprise normalizing a frequency spectrum to values ranging from 0 to 1.

31. The non-transitory computer-readable medium of claim 28, wherein the steps further comprise defining an operator associated with the high eigenvalues.

32. The non-transitory computer-readable medium of claim 28, wherein the steps further comprise controlling the spectrum of the learnable high-frequency filters.

33. The non-transitory computer-readable medium of claim 28, wherein the steps further comprise generating a normalized N×N Laplacian Matrix for at least one learnable filter.

34-41. (canceled)
